(19) United States
(12) Patent Application Publication
(10) Pub. No.: US 2012/0166955 A1
(43) Pub. Date: Jun. 28, 2012

(54) SYSTEM AND METHOD FOR INTERACTIVE EVENT DISPLAY

(76) Inventor: Michael Bender, Bethel Island, CA (US)

(21) Appl. No.: 13/329,176

(22) Filed: Dec. 16, 2011

Related U.S. Application Data
(60) Provisional application No. 61/427,666, filed on Dec. 28, 2010.

(51) Int. Cl. G06F 3/01; G06F 15/16

(52) U.S. Cl. 715/733

(57) ABSTRACT

A system and method for receiving structured data including sporting event information and graphing relative scores of the event on a timeline together with indicia indicative of significant moments related to the sporting event. Interactivity includes receiving a user selection to display details about the sporting event in either text, audio or video. The system may also email the graph of the sporting event or post the graph to social media sites.

### PRIORITY

This application claims the benefit of provisional patent application No. 61/427,666 entitled “System and Method for Interactive Event Display” by the same inventor filed on Dec. 28, 2010 which is incorporated by reference as if fully set forth herein.

### BACKGROUND

The present invention relates generally to a system and method for interactive event displays, and more particularly to the graphical presentation and interactivity of sporting events.

The sporting industry is one of the larger industries in the United States. Significant amounts of print and broadcast media are dedicated to providing the public with information about sporting events. Often this information is the presented in newspapers as game summaries which indicate that statistics of the game. These are commonly referred to as “wrap ups”, “box scores” and the like. Box scores are used to quickly convey to a reader what occurred during the sporting event. Generally these are limited in scope showing only that during a certain part of a game a significant event occurred. They may also indicate a player associated with a significant event so that the player and the player's impact are also reported.

The ability to convey the results of a sporting event quickly and efficiently is valuable for consumers who have limited time to spend on recreational activities.

In broadcast media, event information is presented as “highlights” with the media provider broadcasting certain portions of a sporting event that they hope will interest their viewers. These highlights are designed to quickly convey game information, often lasting only a few seconds per highlight. In these cases the user is only presented with a limited view of the event. Either a static display or another's opinion of what the user would like to see about that event. As such, what is needed is a system and method for presenting a holistic view of an contest and allowing a user to select more information from the display.

### BRIEF DESCRIPTION OF THE DRAWINGS

FIG. 1 shows a functional block diagram of a client server system.

FIG. 2 illustrates a display of a sporting event in accordance with some embodiments of the current disclosure.

FIG. 3 illustrates a display of a baseball game according to some embodiments of the current disclosure.

FIG. 4 shows an example illustrating a display of a college football sporting event.

FIG. 5 illustrates a relatively unexciting sporting event.

FIG. 6 illustrates a relatively high excitement sporting event.

FIG. 7 illustrates user interactivity elements according to the current disclosure.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices such as or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless devices such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

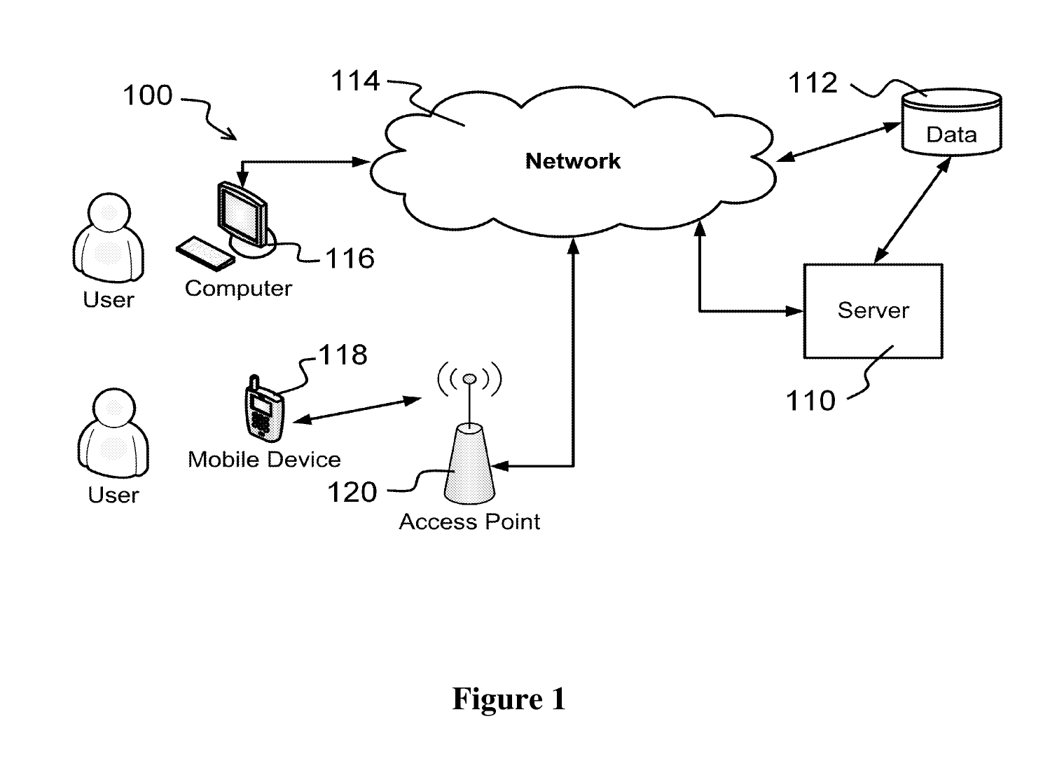

FIG. 1 shows a functional block diagram of a client server system 100 that may be employed for some embodiments according to the current disclosure. In the FIG. 1 a server 110 is coupled to one or more databases 112 and to a network 114. A user accesses the server by a computer 116 communicably coupled to the network 114. Alternatively the user may access the server 110 through the network 114 by using a smart device such as a telephone or PDA 118. The smart device 118 may connect to the server 110 through an access point 120 coupled to the network 114.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

In accordance with the current disclosure, displaying includes showing information to a user, formatting information for a user to display on a local device, transmitting information in a format that can be displayed on a remote device and the like. One having skill in the art will recognize that formatting information into graphics files, PDF files, HTML documents and the like, for transmission to a remote device for display constitutes displaying the information.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, a user interface and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Structured Data

Events may be recorded (or persisted) in several ways. The most common way is to record an event by time. This allows for presentation of the event along a timeline. A structured data source such as a spreadsheet, XML file, database and the like may be used to record events and the time they occurred. The techniques and methods described herein may be effectuated using a variety of hardware and other techniques that persist data and any of the ones specifically described herein are by way of example only and are not limiting in any way.

An event may be recorded by the other events that occur during the event. For example during a baseball game a number of pitches occur. Each pitch would be an event that could indicate the movement of the baseball game from start to finish. In the case of baseball, the game is played in innings, so the inning count could also be used as a basis for indicating the movement of the game from start to finish.

Other sports such as basketball could have points scored, possessions and shots that could be used to indicate the play of the game. In the case of football, possession, downs, turnovers and drives could be used to indicate the movement of the game from start to finish.

Sporting events use score to indicate wins or losses. A structured data source could store events along with their associated score thus allowing the data source to indicate the affect of an event on the score of the game. Also the structured data source could store information on the game participants associated with the event.

Table 1 illustrates one possible structured data source that may be used in certain embodiments of the current disclosure.

TABLE 1

| Time | Pitch | Inning | Batter | Pitcher | Type | Home | Away |
|---|---|---|---|---|---|---|---|
| 4.5 | 3 | 1 | Bender | Tormey | Curve | 1 | 3 |
| 5.5 | 4 | 1 | Bender | Tormey | Breaking | 1 | 3 |
| 6 | 5 | 1 | Bender | Tormey | Fastball | 1 | 3 |
| 7 | 6 | 1 | Mays | Williams | Fastball | 2 | 3 |

The information stored in the Table 1 may used to graphically display the sporting event by graphing it according to the time column, the pitch column, the inning column or other suitable data field. Graphically depicting the sporting event by pitches provides a significant improvement over a mere display based on time because the number of pitches is indicative of the action in a game.

One having skill in the art would recognize that a more complete picture of a sporting event may be accomplished using more data than that depicted in the Table 1. For example, the structured data source may include the count, the call, other participants and the like. One having skill in the art will also recognize that a relational schema for a structured data source may provide for a more efficient operation by reducing redundancy in the data source and improving access times. The information in the structured data source may be collected from remote data sources or may be links to the source of the information reducing the requirement to store the data locally.

Many sporting events lend themselves to multiple movement indications. For example football uses plays, downs and the like. One having skill in the art would recognize that a structured data source may be constructed for many different sporting events to effectuate multiple movement indications with each movement indication illustrating a different aspect of the sporting event.

In a networked computer system, a user might be provided an interface that allows them to designate sporting events and upload corresponding event information. Alternatively, an engine may be employed to collect information about events and persist the data for use as described herein. For example and without limitation a data engine may control the structured data by allowing manipulations such as appending, formatting, sorting and deleting data.

### References

The structured data source may also include references. For example, a reference might point to a file. The file could be an image file such as an icon or other graphic file that would indicate the occurrence of a significant moment during the event. For example, the data source might have a reference that points to a file called “turnover.jpg.” The file turnover.jpg is an image that can be displayed when a turnover occurs in a football game. Similarly a baseball game may have references to an image file used when a grand slam is hit during a baseball game.

Other references may include pointers to audio or video files. These files could be used to display the sight or sound of a significant event. For example, the reference might point to an audio clip announcing the event. The audio clip might be a recording of the on-air broadcast of the sporting event describing the significant moment in the event. Likewise, the reference may be a video file showing the moment.

In a networked computer system, a user might be provided an interface that allows them to designate significant events and upload corresponding reference files or to use a reference to point to information such as that describe in the Table 1.

The above illustration provides many different embodiments or embodiments for implementing different features of the invention. Specific embodiments of components and processes are described to help clarify the invention. These are, of course, merely embodiments and are not intended to limit the invention from that described in the claims.

### Event Display

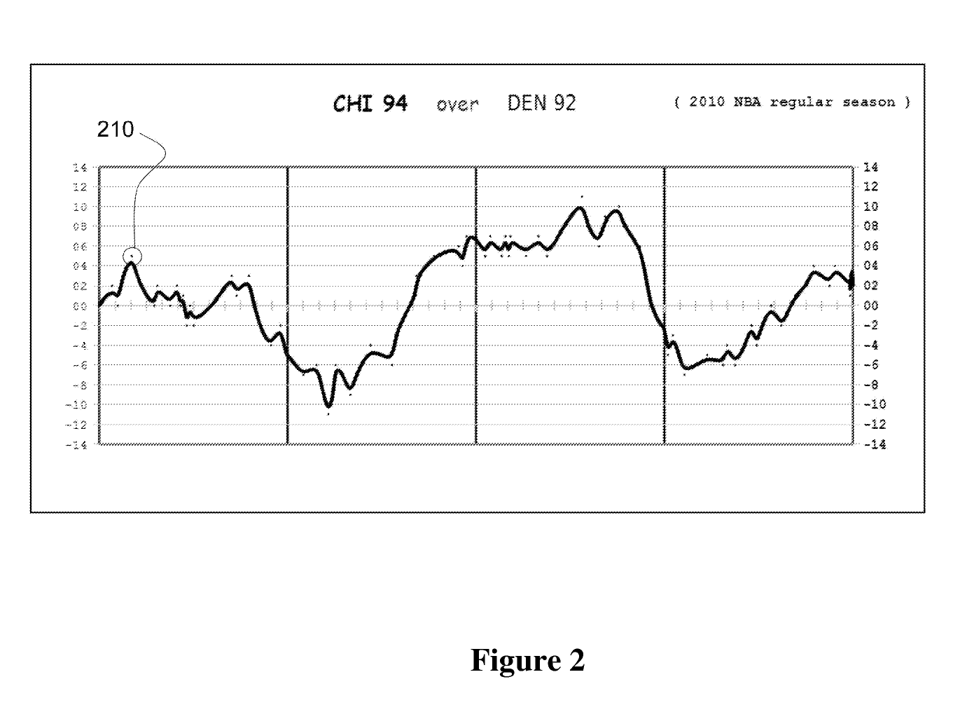

FIG. 2 illustrates a display of a sporting event in accordance with some embodiments of the current disclosure. In the FIG. 2 a basketball game, played between Chicago and Denver is presented. The depiction shows a line representing the difference in points (the “relative score”) between the two teams with the winning team shown as a positive number. Significant events, in this case 3 point baskets, are shown as a dot drawn near the score line at the time the significant event occurred 210. In the FIG. 2 the relative score is smoothed to better illustrate the flow of the sporting event and one having skill in the art may apply other graphical techniques to illustrate event dynamics.

One advantage to the display illustrated by the FIG. 2 is that a viewer can quickly grasp how the flow of the sporting event played out. They can see which side was winning and when in the game the play changed to favor one team over the other. In a close game the line would cross the horizontal axis many times. In a rout or significant victory, the line would move up or down and not cross the horizontal axis often.

One having skill in the art could use a cross-platform, browser-based application development tool such as FLASH by ADOBE to read structured data files such as XML files and display them in an interactive environment such as those shown and described herein.

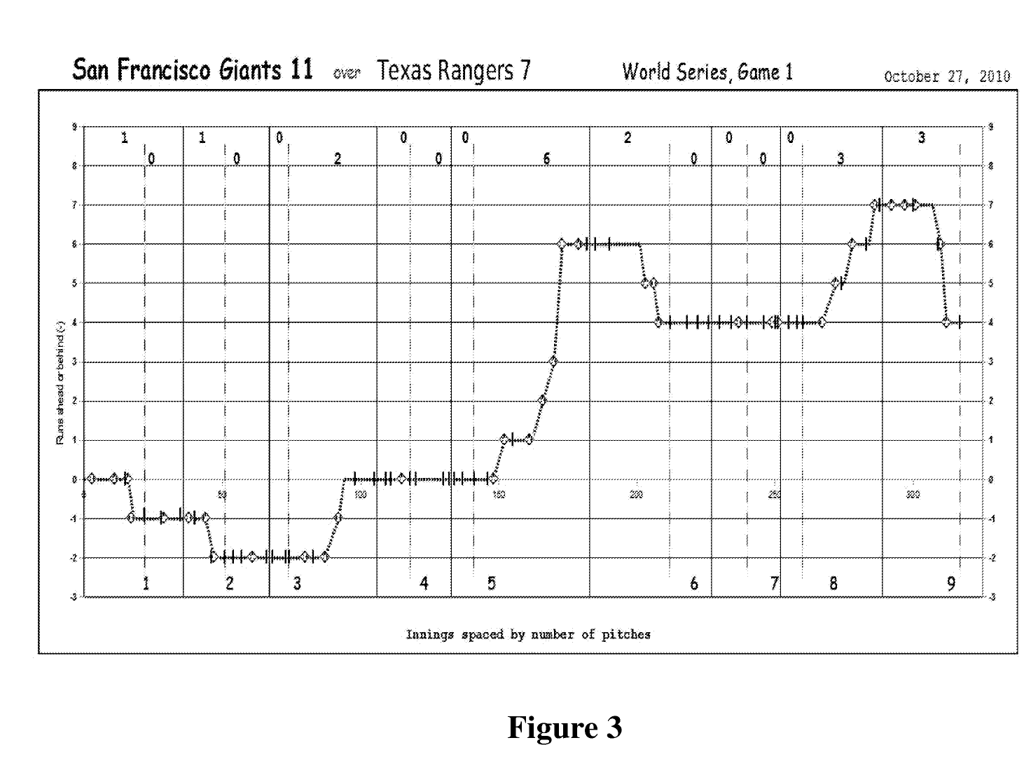

FIG. 3 illustrates a display of a baseball game according to some embodiments of the current disclosure. In the FIG. 3 a baseball game is graphed according to innings and pitch count such that the horizontal axis is scaled by pitch. For each pitch any corresponding score change is reflected as a difference in score between the winner and the loser. Significant events are shown by several different graphics or icons indicating what event occurred. For baseball these events may be home runs, grand slams, strikeouts and the like. In the FIG. 3 the number of icons indicates the amount of action and allows for people to see at a glance the quality of the game.

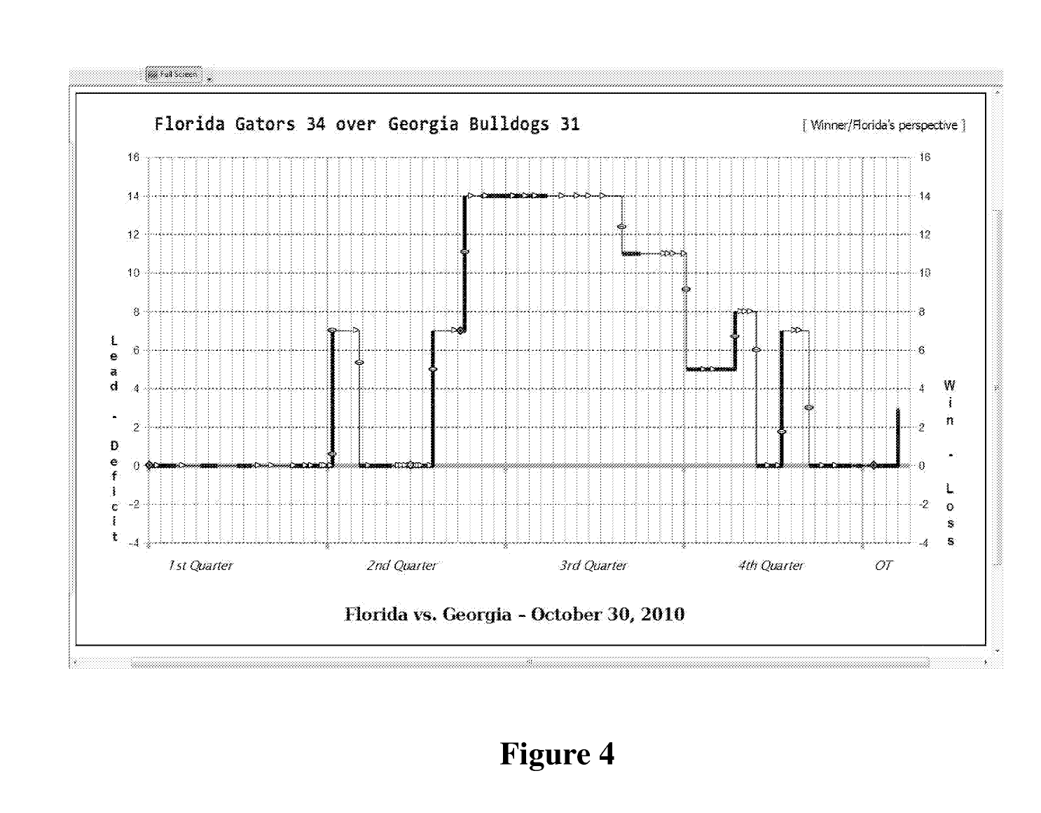

FIG. 4 shows an example illustrating a display of a college football sporting event on a computer screen. In the FIG. 4 the difference in score between the University of Florida and the University of Georgia. In the FIG. 4 possession of the football is indicated by a thicker line on the graph. Icons indicate significant events that occur during the game. For football these significant events may be first downs, field goals, turnovers and the like. In the FIG. 4 the icons indicating significant events are shown on the score line, however, one having skill in the art will recognize that these icons may be placed elsewhere and still effectuate the same result.

Color could be used to indicate possession instead of or in combination with line width. Also, color could be used to indicate the area under the relative score line using different colors for different teams. For example, the area between the baseline and the relative score line could be colored with the team colors of the team currently in the lead. The graphical displays presented herein provide a gestalt of sporting events that is currently unavailable elsewhere.

An analysis of the sporting event in the FIG. 4 indicates other advantages to the graphical presentation presented herein. It is easy for a user to see at a glance if one team dominated the other. For example, in the FIG. 4 it is clear that the University of Florida dominated Georgia throughout most of the game at one time having a 14 point lead. The presentation in the FIG. 4 quickly allows a user to grasp the speed and ease of understanding “what happened” in a game. It is easy for a user to spot and count lead changes, and see how the difference in score during the game is of primary importance to viewers.

### Excitement Level

One feature of sporting contests is the amount of excitement a game can have. Referring to the FIGS. 2 through 4 different graphical techniques may indicate an excitement level. One technique is to count the number of times a relative scoring graph crosses zero on the horizontal axis. Each time the relative score crosses zero, the lead in the game changes. Thus a count of times the relative score crosses zero would indicate a measure of excitement for the game. A user could identify excitement levels from a collection of sporting events and select which event to view in response to that identification. Similarly a count of the local maxima and minima for a graph line will also indicate excitement because each local maximum or minimum would indicate a change in score. For low scoring sports like hockey there are only a small number of local maxima or minima, whereas other sports like basketball may have dozens of local maxima and minima.

Another indication of excitement is unanticipated changes such as those shown in the FIG. 4. In the FIG. 4 the score at the end of the football game was zero. It was during overtime that the game score changed and the game ended. Thus analysis of scoring towards the end of the game might indicate a level of excitement. Also a long protracted time of zero difference in relative score could indicate excitement because this could indicate a prolonged tie game which may occur between two equally matched teams.

Another measure of excitement would be a pronounced decrease in dominance by one team over another. In the example of FIG. 4, the 14 point loss in relative score during the second half is a measure of how much action (and hence excitement) there was during that portion of the game. The 14 point loss in such a short period of time is also an indicator of excitement. Combined changes in score over time periods effectuate an indication of interest.

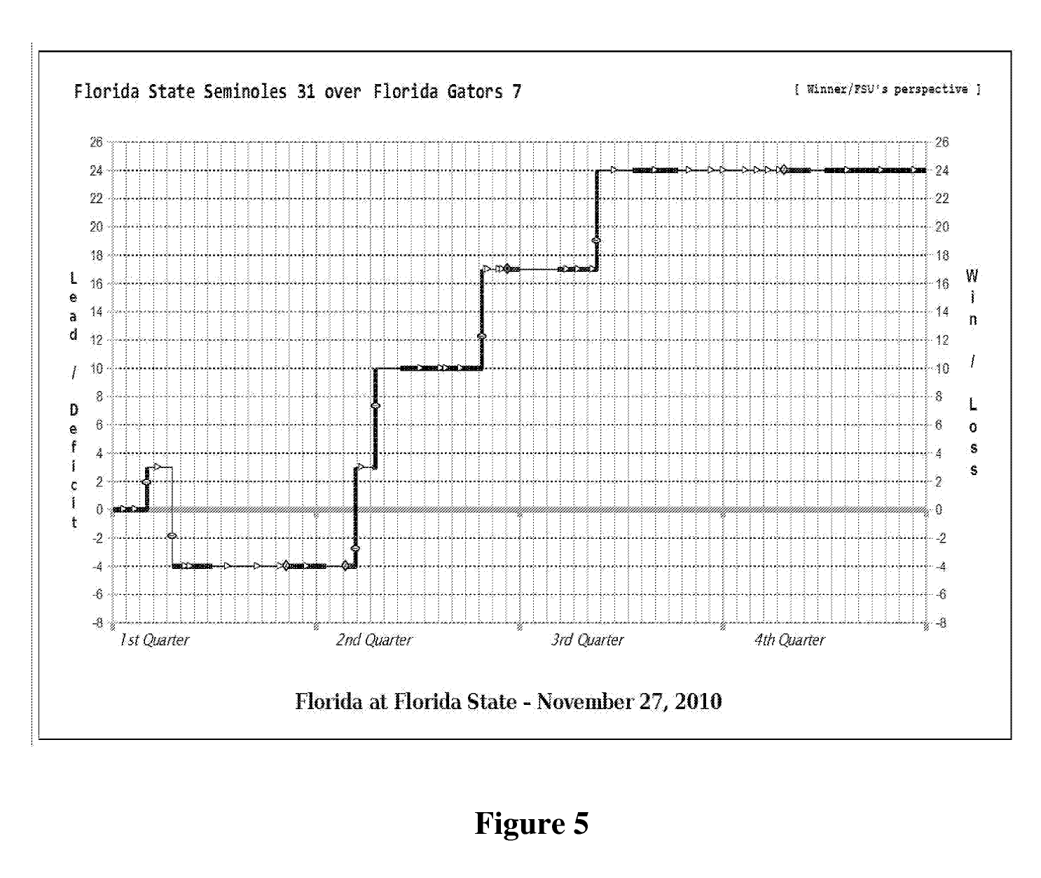

FIG. 5 illustrates a relatively unexciting sporting event. In the game depicted by the FIG. 5 there are few indications of excitement (except of course to FSU fans). There is only one local minimum score and it's clear from the constantly increasing relative score that the winning team dominated the losing team throughout the game. Also, the plot of relative score only crosses the horizontal axis twice—another indicator of low excitement.

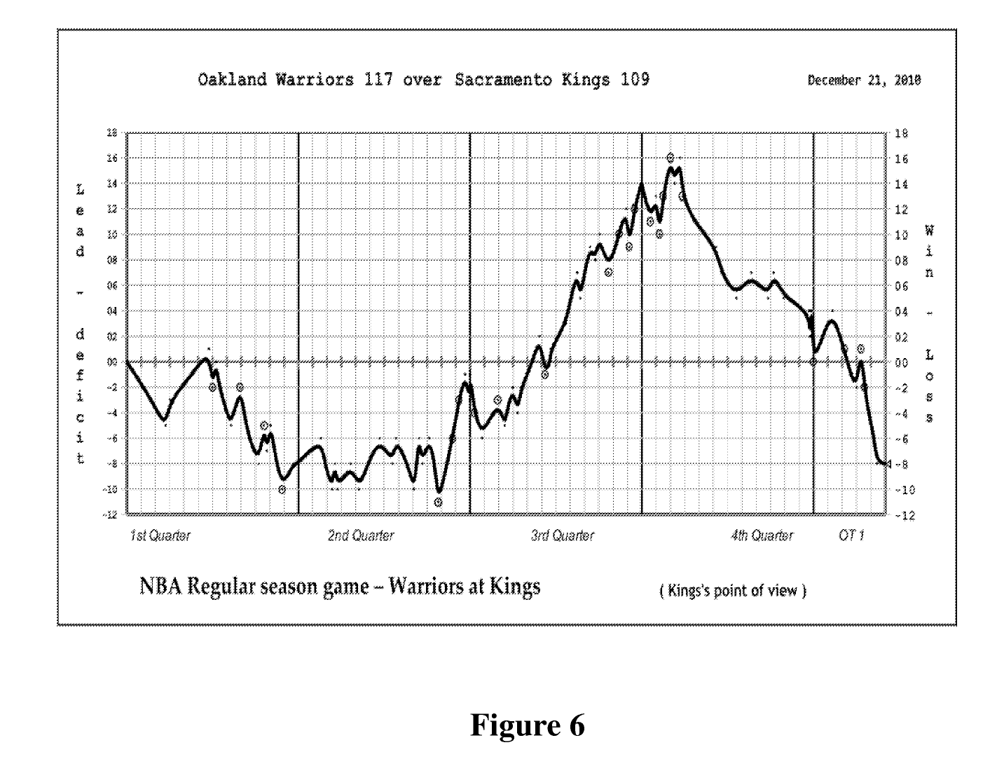

FIG. 6 illustrates a relatively high excitement sporting event. In the FIG. 6 there are dozens of local maxima and minima as well as several instances where the lead in the games changed or the relative score was zero. There are also numerous significant event icons indicating 3 point shots on the basket. Accordingly, combinations of these indications of excitement could be combined to effectuate a single indicator of relative excitement of a sporting event. An example of a combination may be:
# of local minima+# of local maxima+# of 3 point shots
   Certain calculations allow for relative excitement determinations independent of the type of sporting activity or event.

### Interactivity

When the graphical information is displayed on a processor-based I/O device such as a computer monitor or smart device display, the display may be interactive. Interactivity may be achieved, among other ways, by using a commercially available event-driven display tool. Such a tool would electronically indicate the position of a pointing device such as a finger, mouse and the like in relation to the graphical display. A display engine containing processor-readable instructions would acquire the position information and perform task in response to that information. By way of example only, these tasks might be:
Displaying a picture from that portion of the sporting event,
Displaying a video of the portion of the sporting event,
Playing audio from that portion of the sporting event,
Playing user-generated media, or
Displaying information about the portion of the sporting event such as player, a written description or statistics.

The above list is not exhaustive in that other interactivity could be employed. To effectuate the above-described interactivity, the display engine could receive from the display the pointer coordinates and determine position in the event from the structured data source. When position is known, actions such as linking to references may be effected. These references could be a variety of data sources that contain audio, visual and other media elated to the sporting event.

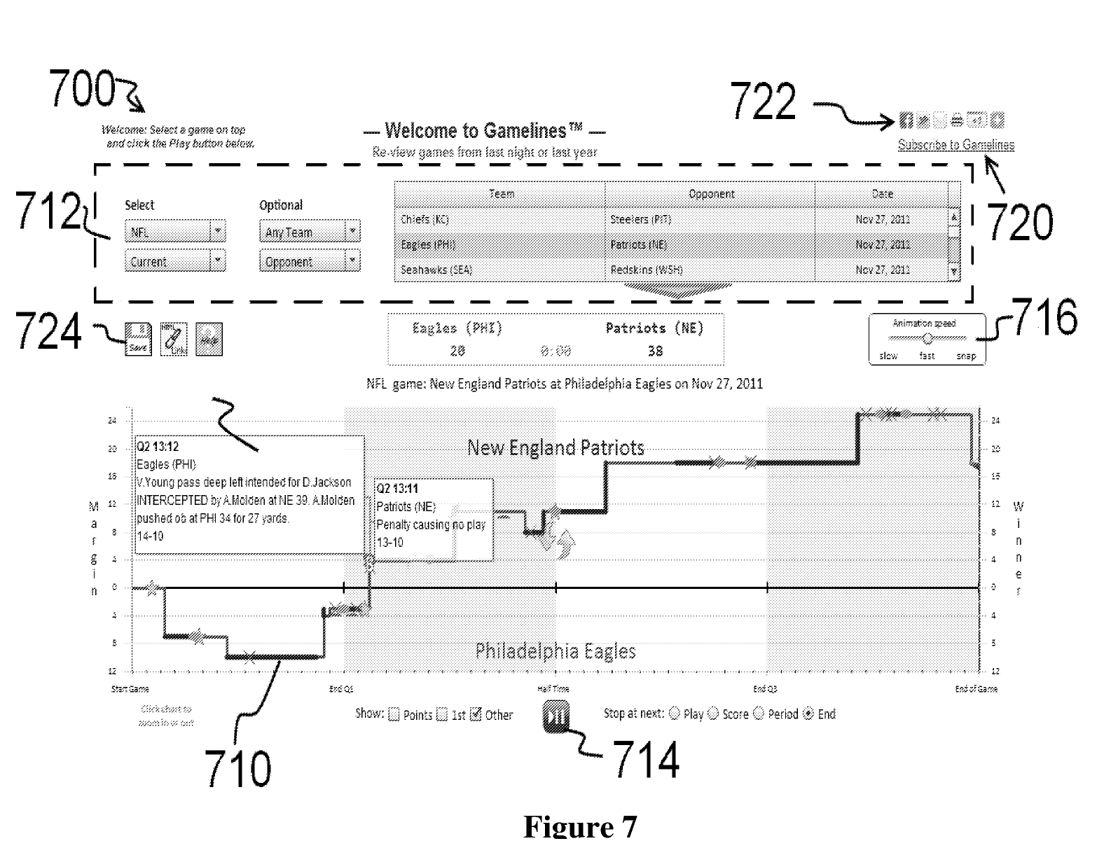

FIG. 7 illustrates user interactivity elements according to the current disclosure. In the FIG. 7 a display 710 of a sporting event is generated in response to a user selecting an event using a set of controls 712. The display may be controlled by a play button 714 that directs the display 710 to advance in time showing the relative scores and placing icons on the display 710 indicating significant activity that occurred during the sporting event. The activity and time to display may be controlled using conventional display controls such as check boxes and radio buttons as shown in FIG. 7. The playback speed may be controlled using and animation speed control 716.

Placing a pointing device over a portion of the display 710 or an icon associated with a point of the display 710, may trigger an event that displays details 718 about that time period of the display 710. The details 718 may include sporting activity, procedural information, player statistics and the like. In addition a user may subscribe to a series of events using a subscribe control 720. For example and without limitation, a subscription may include all the games for a particular team. The subscription service would generate the appropriate image, (such as display 710) for the team and send that image in an email, or send a pointer to where on the Internet that image may be seen.

Social media controls 722 may be used to publish to associated social media venues information about the event displayed including, but not limited to, the display 710. Social media may include FACEBOOK, LINKEDIN, TWITTER and the like. Similarly, the image created by the display 710 may be saved, edited or emailed using controls 724.

A user interface could allow for users to upload their own sporting event information including files or links to files that contain media about the event. A user interface may also allow a user to “play” the sporting event as it is constructed on a display device. The play function would allow the user to watch the action unfold as the sporting event progresses. Additionally, the user could set the play operation to pause at significant events and display those media files (or portions thereof) for a short time. In this manner, interactivity allows a user to select portions of the sporting event that interest the user and create their own highlights feature. Advantages to the interactivity function are that a user may select their own significant events to watch or can quickly review a sporting event and have an audio or visual display of all the highlights in view of the excitement and relative score of the sporting event as it progresses. A sports enthusiast could quickly review a whole day's worth of sporting events and their affect on the sporting events.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A system including:
a server, said server coupled to a structured data source, said structured data including at least a sporting event history.
a data engine operable to control the structured data;
a display engine operable to format the structured data into a graph, said graph depicting a relative score between two rivals in the sporting event, and
a user interface operable to provide the graph to a user and to receive input from the user.

2. The system of claim 1 wherein the user interface is operable to display information about a significant moment in the sporting event history in response to the input from the user.

3. The system of claim 2 wherein the information about a significant moment includes a text display with at least a portion event information.

4. The system of claim 2 wherein the information about a significant moment includes either an audio or video indication of at least a portion event information.

5. The system of claim 1 wherein the structured data is XML.

6. The system of claim 1 wherein the display engine is further operable to transmit the graph as an email attachment or to transmit a hyperlink to the graph.

7. A method comprising:
receiving, at a server, a structured data source, said source including at least event information;
graphing at least a portion of the event information on a timeline;
disposing indicia indicative of an activity related to the event, said disposing associated with a point on the timeline;
sending the timeline and indicia to a remote device, and
receiving, at the server, a user selection in response to said sending.

8. The method of claim 7 further including:
sending details about the event in response to the user selection.

9. The method of claim 8 wherein the details include a text display describing a significant moment of the event.

10. The method of claim 8 wherein the details include at least one of either an audio signal or a video signal, said signals associated with a significant moment of the event.

11. The method of claim 7 wherein the event is a sporting event.

12. The method of claim 7 wherein the graphing includes a relative score between two or more rivals.

13. The method of claim 7 further including:
posting the timeline and indicia to a social media web site.

14. The method of claim 7 further including:
emailing the timeline and indicia.

15. One or more processor readable storage devices having non-transitory, processor readable code embodied on said devices, said code operable for instructing one or more processors to:
receive a structured data source, said source including at least sporting event information;
graph at least a portion of the event information on a timeline;
dispose indicia indicative of an activity related to the event;
send the timeline and indicia to a remote device, and receive a user selection in response to said sending.

16. The method of claim 15 wherein the code is further operable to:
send a text display describing a significant moment of the event.

17. The method of claim 15 wherein the code is further operable to:
send at least one of either an audio signal or a video signal, said signals associated with a significant moment of the event.

18. The method of claim 15 wherein the code is further operable to:
post the timeline and indicia to a social media web site.
